(19) United States
(12) Patent Application Publication
(10) Pub. No.: US 2016/0184953 A1
(43) Pub. Date: Jun. 30, 2016

(54) Computer assisted position device for hollowing and duplicating when woodturning

(71) Applicants: Stanley Dale Harder, Omaha, NE (US); J. Thomas Steyer, Omaha, NE (US)

(72) Inventors: Stanley Dale Harder, Omaha, NE (US); J. Thomas Steyer, Omaha, NE (US)

(21) Appl. No.: 14/794,933

(22) Filed: Jul. 9, 2015

Related U.S. Application Data
(60) Provisional application No. 62/022,789, filed on Jul. 10, 2014.

(51) Int. Cl. B23Q 17/24; H04N 5/232; H04N 5/265; H04N 5/225; B27C 7/00; B23Q 17/22

(52) U.S. Cl. CPC B23Q 17/2409; B27C 7/00; B23Q 17/2233; B23Q 17/2414; H04N 5/265; H04N 5/2251; H04N 5/23293

(57) ABSTRACT

A digital camera is attached to an arm that is fixed in position relative to a cutter at the end of a cutter used for hollowing a wooden object on a wood lathe. An image of the cutter is captured by a computing device attached to the camera. That image is superimposed on the screen of the computer over the live camera image such that when the cutter is moved into the object being hollowed, the position of the cutter relative to the object is known. The same device can be used for duplicating as well by superimposing, on the screen, a captured image of the object to be duplicated over the live video of a piece of wood on the lathe.

This is a nonprovisional application of a provisional application No. 62/022,789, filed 2014 Jul. 10

### BACKGROUND

When woodturning on a lathe by hand, it is difficult to know the dimensions of what is being turned or the wall thickness of a hollow vessel without stopping the lathe and using some sort of caliper device to measure the turning. When creating a deep vessel or one with a small opening, it can be difficult to fabricate a caliper with the proper dimensions to fit into and measure the wall thickness at each point along the surface of the vessel. Over time, several attempts have been made to create an apparatus that assists the woodturner in these tasks. To increase productivity, such a device would not require the lathe operator to turn off the lathe to use said device.

One attempt at solving the hollowing issue is to attach a feeler arm to the hollowing tool that ends at a point within a given distance from the cutter. This is awkward and is hard to adjust for different positions around the surface of the vessel. The most common modern solution to the problem is to mount a laser pointer to the end of an arm affixed to the cutting bar so the laser is pointing down perpendicular to the plane of freedom of the hollowing tool bar. The laser is oriented so that the laser light points to a position in space beside the cutter, at a distance which corresponds with the desired wall thickness. When using such a device, the cutter, which is inside the vessel, is moved toward the wall of the vessel until the laser dot falls off of the side of the vessel. This method is useful but not very accurate and requires continual adjustment of the laser so that it is oriented on the side of the cutter perpendicular to the surface of the vessel.

No equivalent commonly used method exists that allows live measurement of both position and diameter of details while duplicating on a lathe without turning off the lathe and holding a template or caliper up against the turning.

### BRIEF DESCRIPTION OF THE INVENTION

An embodiment of this device is a digital camera mounted on an arm that is fixed in position relative to a lathe hollowing apparatus. The camera looks down onto the cutter at the end of the hollowing apparatus. An image is taken of the cutter and is stored in a computing device. The cutter image is isolated from the surrounding background and superimposed over the live video-feed from the camera on a monitor. The operator can then see exactly where the cutter is inside the vessel at all times. Additionally, a line can be drawn by the computing device at a specified wall thickness away from the cutter to indicate to the operator how close the image of the cutter can come to the edge of the vessel to create that desired wall thickness. Similarly, when doing spindle turning and attempting to duplicate a previously turned object, this device can be used to visually see the desired shape of the object superimposed over the piece of wood currently being turned. In this configuration, the camera is positioned at a fixed point over the center-line of the lathe focused down onto the turning.

### BRIEF DESCRIPTION OF DRAWINGS

FIG. 1 shows an embodiment of this invention attached to a lathe and a hollowing apparatus.

FIG. 2 shows the display of the invention during a hollowing operation.

FIG. 3 shows an embodiment of this invention attached to a lathe for the purpose of duplicating.

FIG. 4 shows the display of the invention during a duplicating operation.

### DETAILED DESCRIPTION OF INVENTION

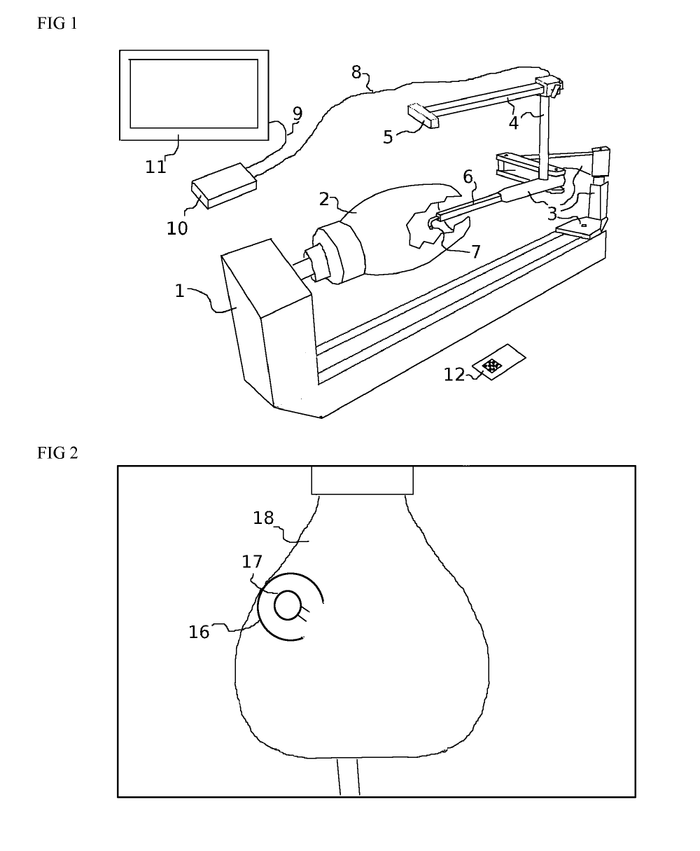

The first application of the invention is shown in FIG. 1. A digital camera 5 is mounted above the cutter of a captive or articulated hollowing rig 3 on a woodturning lathe. The camera is affixed to an adjustable arm assembly 4 which allows adjustment of the position of the camera so that it is approximately above the cutter 7 which is at the end of the hollowing rig assembly bar 6. The adjustable arm assembly 4 is affixed to the hollowing rig 3 in such a way to ensure that its position relative to the cutter 7 does not move during operation. The digital camera 5 is connected via a cable 8 to a computing device 10. That computing device 10, in turn, is attached to a video monitor 11 by a cable 9. The monitor 11 acts as the computing devices display. A computer mouse and/or remote control is used to control the operation of the software running on the computing device.

The camera 5 must first be calibrated so the scale of the cutter 7 is known. This will allow display of dimensions on the monitor during operation of the device. The calibration target card 12 is held near the vertical level of the cutter during this operation. The calibration target card 12 has a pattern printed on it of a predetermined dimension. The software identifies the platter on the card and can calculate the size of each pixel at the current distance to the cutter 7 from the camera 5.

In an alternative implementation of the invention, the user is required to enter the distance from the camera 5 to the cutter 7. This will give the software enough information, along with the known viewing angle of the camera 5, to calculate the size of each pixel as they relate to the real world near the cutter 7.

Under user control, the software next will capture an image of the cutter 7, while the cutter 7 is not inserted into the vessel 2, and determine its peripheral shape as viewed from the camera 5. Because the background image of the floor of the workshop below the cutter 7 is likely not clean and uniform in color, some assistance by the user is required to help the software find the cutter in the image. A target region is drawn on the screen 11 which restricts the area the software needs to look to find the cutter. The user is required to hold a solid colored card or object below the cutter to more clearly show the software which pixels are part of the cutter 7 and which ones are part of the background.

In an alternative implementation, the software could record the camera images as the operator moves a card or other object under the cutter 7 and determine which pixels are fixed and which pixels are changing colors. After a short time, the software will know which pixels are part of the cutter 7 and which pixels are not.

FIG. 2 shows an example representation of the display during a hollowing operation. After the software identifies the cutter 17, it calculates the path around the periphery of the cutter 17 and draws that line 16 on the screen. The image of the cutter 17 is used as an overlay over the live video feed coming from the camera 5. In this way, when the cutter 7 is inserted into a vessel 2 being turned on the lathe, the overlay image of the cutter 17 will remain on the screen, and it will appear to the operator that they are looking at the cutter through the wall of the vessel. At this point, the operator will be able to see the location of the cutter 17 within the vessel image 18 by looking at the monitor 11.

In order to know the distance the cutter 7 is from the exterior surface of the vessel 2, the software provides additional assistance in the form of a line 16 on the screen 11 around the image of the cutter 17 that is the distance from the cutter 7 which the operator has entered as a desired wall thickness into the computing device 10. The distance this line is drawn from the cutter image 17 is calculated based on the calibration done earlier to determine the scale of each pixel at the cutter 7 distance from the camera 5. Now the operator can move the captive hollowing rig 3 and camera assembly 4 and 5 such that the wall thickness line 16 comes up to the edge of the live video feed of the vessel 18 exterior. At that point, the desired wall thickness is reached.

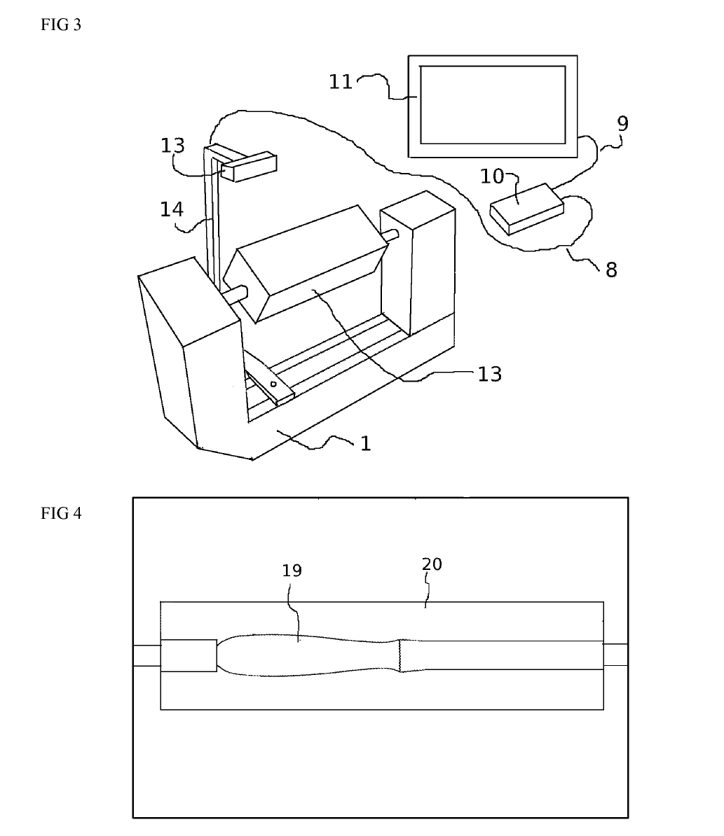

The second application of the invention is shown in FIG. 3. A camera 13 is attached to a support arm assembly 14 in a fixed position above the axis of the lathe. A turned object which the operator wishes to duplicate is placed on the lathe 1 between centers or attached to a chuck or faceplate. An image of the object is captured by the software. The imaging processing software of the invention detects the edges of the image using an edge detection algorithm. Those edges can be added to the display image to highlight the contours of the object being duplicated

That image of the original turning 19 and optional edges which were detected are displayed as a semi-transparent overlay over the video feed. When a new wood blank 13 is inserted into the lathe, as shown in FIG. 4, the shape of the original object 19 is superimposed over the live image of the wood blank 20. In this way, the operator will see exactly where the cuts need to be made to duplicate the turning.

Additionally, the software in the invention allows the user to interactively erase the background of the overlay by selecting colors on the screen which are not part of the original turning, using a mouse or remote control. In this way, the position of the tool and the uncut wood is not obstructed by the overlay and the operator can have a clear view of the work being done.

1. A camera mounted on a ridged support to a captive hollowing system. The camera is attached to a computing device. The computing device is attached to a video monitor. By displaying an image of the cutter and other annotated markings, as an overlay over the live video of the object being turned, the computing device assists the operator of a woodturning lathe to know the position of a cutter inside a vessel and to know the distance the cutter is from the outside of the vessel or form being turned.

2. A camera mounted at a fixed position above the center-line of a woodturning lathe. The camera is attached to a computing device. The computing device is attached to a video monitor. The computing device assists the operator of a woodturning lathe to see a template of the desired shape of the turned object on the monitor as an overlay over the object being turned.
